(19) United States
(12) Patent Application Publication
(10) Pub. No.: US 2008/0282238 A1
(43) Pub. Date: Nov. 13, 2008

(54) STATIC TYPE FOR LATE BINDING

(75) Inventors: Henricus Johannes Maria Meijer, Mercer Island, WA (US); Peter A. Hallam, Seattle, WA (US); Anders Hejlsberg, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/746,995

(22) Filed: May 10, 2007

(51) Int. Cl. G06F 9/44

(52) U.S. Cl. 717/162

(57) ABSTRACT

A static type computer language provides optional dynamic typing triggered by a unique static type. The unique static type can be utilized anywhere other types can be employed to identify programmatic elements that are late bound. As a result, static types can be analyzed at compile time while deferring analysis of dynamic types until runtime.

### BACKGROUND

Computer programs are groups of instructions that describe actions to be performed by a computer or other processor-based device. When a computer program is loaded and executed on computer hardware, the computer will behave in a predetermined manner by following the instructions of the computer program. Accordingly, the computer becomes a specialized machine that performs the tasks prescribed by the instructions.

A programmer using one or more programming languages creates the instructions comprising a computer program. Typically, source code is specified or edited by a programmer manually and/or with help of an integrated development environment (IDE). Subsequently, the source code can be compiled or otherwise transformed by another program into computer instructions executable by a computer or like device.

By way of example, a programmer may choose to implemented code utilizing an object-oriented programming language (e.g., C#, Java . . . ). In accordance with such a paradigm, programmers will create a number of classes identifying properties and characteristics of an abstract thing as well as methods describing class behavior or abilities. Specific programmatic logic can then be specified as interactions between instances of classes or objects, among other things. Subsequently, executable code for a particular machine can be produced by an associated compiler. Alternatively, code can be transformed into intermediate code for a target virtual machine to facilitate execution on multiple computer platforms via further compilation or interpretation of the intermediate code.

Conventionally, programming languages are either statically typed or dynamically typed. Types provide constraints on the interpretation of data in accordance with a language type system. Accordingly, types can be utilized to detect programming errors via a type checking. In other words, a degree of program safety can be obtained by detecting meaningless or likely invalid code as a function of data types. This can be accomplished either statically or dynamically. A statically typed language enables a program to be type checked at compile time. Accordingly, all types are known at compile time, for example by explicit specification or type inference. Dynamically typed languages differ in that they are type checked at runtime. As a consequence, types need not be explicitly specified prior to use, rather they are determined during execution.

When selecting a language, programmers need to consider tradeoffs between static and dynamic typing. In particular, static typing is beneficial in that errors can be detected prior to execution and programs can execute very efficiently. Further, design time experience can be improved since assistance such as automatic fills and suggestions can be provided based on types. However, dynamically typed languages allow more programmatic flexibility than static typed languages while still providing a degree of type safety via runtime checking. Furthermore, dynamically typed languages are easier to use, as programmers need not be concerned with type specification.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, this disclosure pertains to a static programming language that allows optional dynamic type binding triggered by specification of a unique/special static type (e.g., Dynamic). This type can be utilized anywhere a normal language type can appear. In combination with type inference, this provides the same flexibility and conciseness as dynamic languages with the safety of statically typed languages where possible.

In accordance with one aspect of the disclosure, an early binder is provided that binds static types to program elements or calls at compile time while deferring binding of code associated with a unique static identifier. According to another aspect of the disclosure, a late binder is afforded that can perform late binding of portions of code designated therefor.

In accordance with yet another aspect, a static programming language can be extended to support dynamic typing via compilation modification. More specifically, a specified unique static type can be erased to a normal static type prior to runtime and annotated in a manner to indicate dynamic binding. At runtime, such code can be identified and dynamically bound prior to execution.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a static code analysis system.

FIG. 2 is a block diagram of a representative early binder component.

FIG. 3 is a block diagram of a code analysis system including type erasure.

FIG. 4 is a block diagram of a dynamic code analysis system.

FIG. 5 is a flow chart diagram of a program translation method.

FIG. 6 is a flow chart diagram of static compilation method.

FIG. 7 is a flow chart diagram of dynamic translation method.

FIG. 8 is a flow chart diagram of a method of code development.

FIG. 9 is a schematic block diagram illustrating a suitable operating environment for aspects of the subject disclosure.

FIG. 10 is a schematic block diagram of a sample-computing environment.

### DETAILED DESCRIPTION

Systems and methods are disclosed with respect to provisioning optional dynamic typing in a statically typed language. A unique static type is utilized by programmers to identify dynamic types explicitly amongst other static types. At compile time, static types can be bound to programmatic elements while dynamic binding is deferred. In one instance, the unique static type is replaced with a language standard type to facilitate static type checking and annotated to trigger dynamic typing. Subsequently, elements can be type bound at runtime. This hybrid approach to programming combines benefits of both static and dynamic typing.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

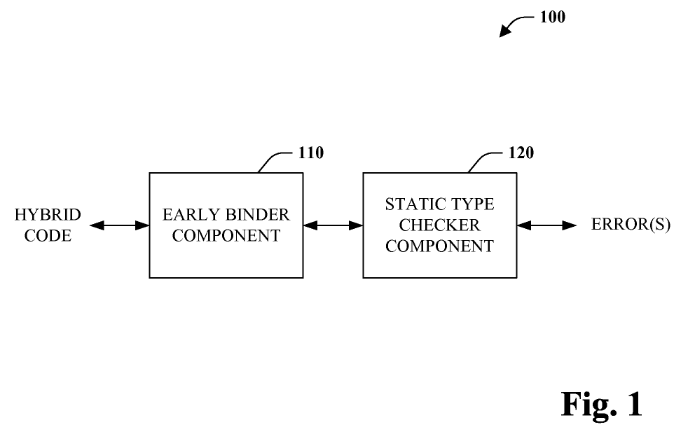

Referring initially to FIG. 1, a code analysis system 100 is depicted in accordance with an aspect of the claimed subject matter. The system 100 can form part of a compiler and operate on a static type language that supports optional dynamic typing. In many situations, exact static types of values are not known (e.g., dynamic loading) or a static type system is not powerful enough to express certain constraints or expectations on values. In these cases, programmers want to use late binding or dynamic typing. In statically typed languages, however, programmers have to use very low-level features such as reflection to achieve late binding functionality. It is much more preferable to have a hybrid language that has static typing where possible but allows dynamic typing where necessary. One approach is to employ a unique static type, for example “Dynamic” that tells a compiler to delay binding until runtime. This type can then been utilized anywhere standard language types can be used.

In system 100, early binder component 110 receives, retrieves or otherwise obtains such hybrid code comprising statically typed code with support for optional dynamic types. The early binder 110 binds static types, explicitly specified or inferred, with programmatic elements (e.g., objects) at compile time. However, the early binder 110 does not, at least initially, attempt to bind code or elements identified as late binding, for example by a unique static type “Dynamic.” Static bindings as well as the rest of the code or representation thereof can be made available to static type check component 120.

Upon receipt or retrieval of such information, the static type check component 120 can type check the code for programmatic errors. In other words, the static type check component 120 analyzes the code prior to runtime in light of the language type system and/or defined types, among other things, in an attempt to identify type errors. For example, an attempt to add an integer and a string would generate a type error. It should also be appreciated that binding errors can be detected and identified by either or both of the early binder component 110 and the type check component 120. For example, an attempt to call a method on an object that does not support the method will generate an error. Any type error can act to thwart compilation or other translation. In this manner, certain runtime errors can be prevented from occurring.

It should be noted that there is enormous competitive pressure from dynamic languages to sway programmers away from static languages and to static languages. However, a statically typed language with optional dynamic typing is a much superior approach. In combination with type inference, this provides the same flexibility and conciseness as dynamic languages with the safety of statically typed languages where possible.

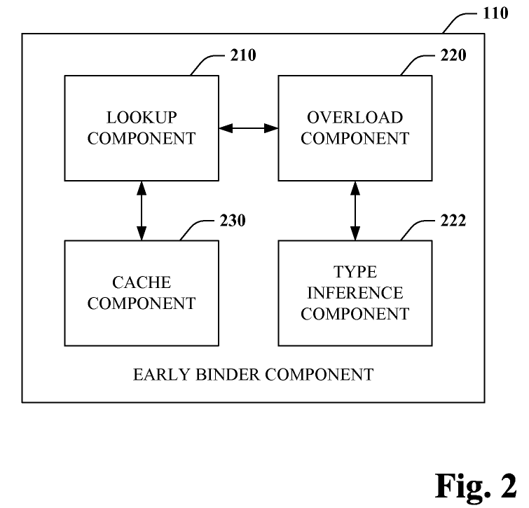

Turning attention to FIG. 2, a representative early binder component 110 is illustrated in accordance with an aspect of the claimed subject matter. As shown, the early binder component can include a lookup component 210 and an overload resolution component 220. The lookup component 110 identifies one or more members as a function of an object type. For example, consider the expression x.length( ) given x is declared type string. The lookup component 110 can access type string and verify that string includes a method length. Accordingly, the method length successfully binds to the type string. However, consider the same expression where x is now of type object. Since type object does not include a method length the lookup component will fail to identify a match.

At times, the lookup component 210 may find more than one match, for example where a method is overloaded. In such an instance, the lookup component 210 can employ the services of the overload component 220 to identify a matching member. The component 220 can perform an overload resolution process to select a single member from amongst a plurality of matches. Such a resolution process can include techniques known in the art. For example, the overload component 210 can consider the number of parameters and/or types associated with parameters, among other things, to resolve the situation. If a single member cannot be identified, an error can be generated.

The overload resolution component 220 can also interface with a type inference component 222 to facilitate overload resolution. In particular, the type inference component 222 can infer types associated with method receivers and/or generic method type parameters. Various mechanisms can be employed to infer types as a function of programmatic context. For example, a generic method type parameter can be inferred from one or more method argument types.

The early binder component 110 also includes a cache component 230 communicatively coupled to the lookup component 210. The cache component 230 is a mechanism for storing, at least temporarily, identified binds. In particular, where a loop exists it is inefficient to perform lookup for the same expression multiple times. Instead, once the binding is first identified the lookup component 210 can employ cache component 230 to store the binding. On subsequent loop iterations, the binding can simply be retrieved from storage to avoid unnecessary lookup operations.

Unlike conventional binders, functionality afforded by early binder component 110 can be deferred for a special static type. Therefore, the lookup component 210, overload component 220 and cache component 230 need to operate with respect to the same. Consider for instance: “Dynamic d=x; d.Length.” Here, the unique type “Dynamic” indicates to the lookup component 210 that a different lookup mechanism should be employed, namely a dynamic lookup. At compile time the early binder component 110 and associated subcomponents need not apply to code associated with the special static type, in this case the expressions “Dynamic d=x” and “d.Length.”

It is to be appreciated that such a unique or special static appear anywhere a “normal” type can appear. Among other things, the special static type can be utilized with respect to constructed types (e.g., arrays, lists, tables . . . ), arguments and results. For example, a type of array of dynamic objects can be created: “Dynamic[ ].” This allows statically typed access to the array itself, but dynamic access to the elements (e.g., Array<Dynamic>). Consider the following exemplary psuedocode:

| Dynamic[ ] xs = ....; | |
|---|---|
| //Array Access | |
| xs.Length; | //Ok |
| xs.Foo( ); | //type error |
| //Element Access | |
| var x = xs[0]; //Ok | |
| x.Foo( ); | //Ok |

Turning first to array access, the type for “xs.Length” is ok because the array “xs” is statically typed and “Length” can be bound to “xs” at compile type. A type error results for “xs.Foo( )” assuming Foo( ) is not an array method. With respect to the element access, “var x=xs[0];” is ok because type “Dynamic” can be inferred as the type of “x.” As a result “x.Foo( )” does not cause an error during compilation as the binding and type checking are deferred until runtime.

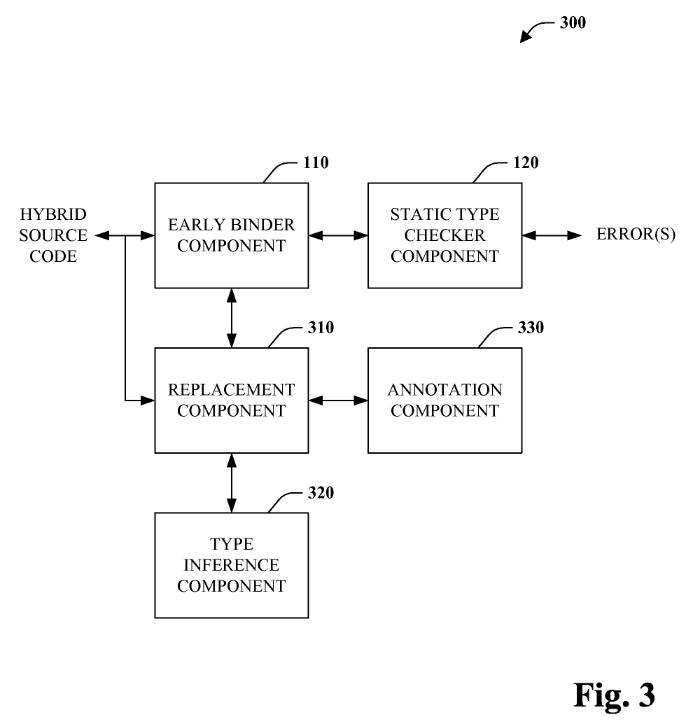

Referring to FIG. 3, a code analysis system including type erasure 300 is illustrated in accordance with an aspect of the claimed subject matter. Similar to system 100 of FIG. 100, system 400 includes the early binder component 110 and type checker component 120, as previously described. In practice, a problem exists with respect to extending an existing static language that does not include the special static type. In accordance with one implementation, the system 300 includes a replacement component 310 that erases or replaces the special static type indicative of late binding with a static type recognized by a language. There is a spectrum of possible erasures.

In one instance, a special type like “Dynamic” can be replaced with a root or super type such as “Object.” However, this may result in a loss of information that could be used in some way such as for partial type checking. For example, suppose code specifies “Dynamic x=“hello world.” The dynamic type could be erased to type “object” to result in “object x=“hello world,” but in some sense information has been thrown away because it can be determined that “x” is of type “string.”

Hence, in another instance, a special type can be erased to an inferred type. In particular, the replacement component 310 can interact with type inference component 320 in an attempt to locate a better replacement type. The inference component 320 can determine or infer a replacement type based on contextual information, among other things. Accordingly, the type inference component 320 can correspond to the same component utilized by a compiler to infer types for implicitly typed code. In another example, a variable can be defined as type “Dynamic” where at compile time it could be inferred that the static type is “Button.” In that case, static type information need not be forgotten. Instead, this type can be encoded as “Dynamic<Button>,” which would erase to “Button.” Under this interpretation, the non-generic type “Dynamic” corresponds to the generic type “Dynamic<Object>.” Hence, where it is not possible to infer a better type via the inference component 320, the replacement component 310 can fall back to a super type like “Object.”

Similarly, note that specification of a special dynamic type does not preclude specification of a normal static type. For instance, a programmer may know statically that the type is going to be a subtype of “Button,” but the programmer would like to allow dynamic typing. Accordingly, they can explicitly specify “Dynamic<Button>.” Such static information can aid not only static and/or dynamic type checking but also intelligent assistance during programming such via suggestions, auto fill and the like. Further yet, the opposite is also possible, namely identification of a type of which the dynamic type is a super type. Hence, one can indicate that the type is going to a super type of “Button,” for example. This distinction can be denoted syntactically. For instance, “Dynamic<−Button>” can indicate a subtype, while “Dynamic<+Button>” can signify a super type.

The replacement component 310 is also communicatively coupled to annotation component 330. If a special “Dynamic” type is replaced with a standard type, there should be an alternate way to indicate that the associated code is to be dynamically typed. The annotation component 320 provides such a mechanism. The annotation component 320 can provide a special annotation for variables, arguments and occurrences of a dynamic type inside other types, among other things. In particular, metadata, data describing data, associated with such code or elements thereof can be added or modified to identify that the code is special. This can be accomplished in a number of ways. For example, language custom attributes like optional modifiers can be employed. Additionally or alternatively, the code can be given a special color or other mark. For instance, if there is a type string it could be colored red or by putting an annotation on it to indicate that the compiler treats this as a special dynamic type.

It is to be appreciated that in certain instances code analysis can be optimized by removing a dynamic notation from a portion of code. Code should be designated as dynamic where it is not possible to determine its type at compile time. However, if a type can be determined at compile time even though it is labeled as dynamic such designation can be removed to enable more efficient runtime behavior. For example, if code corresponds to “Dynamic x=‘hello world’,” the dynamic type can simply be replace with inferred type “string” and dynamic annotation withheld.

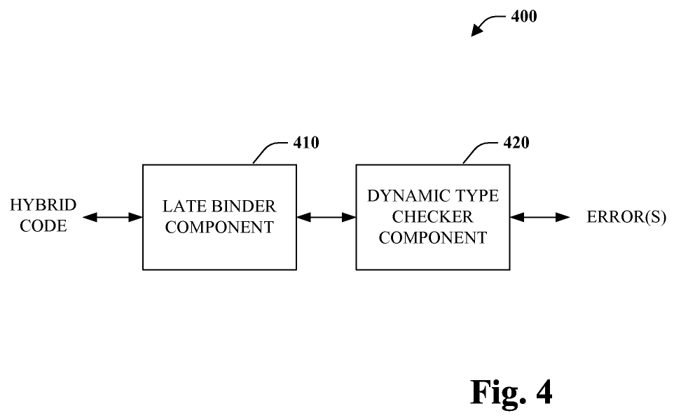

Referring to FIG. 4, a dynamic code analysis system 400 is illustrated in accordance with an aspect of the claimed subject matter. The system 400 operates on compiled static code including a portion of which is identified for dynamic typing. In accordance with an aspect, the system 400 can form part of a compiler such as a just-in-time compiler, interpreter or the like. Similar to the static system 100 of FIG. 1, the dynamic system 400 includes a late binder component 410 and a dynamic type check component 420.

At runtime, the late binder component 410 can operate to bind types to programmatic elements identified as late bound. Such portions of code can be identified via related metadata. For example, the variable assignment “Int y=x.foo( )” can be identified as late bound from an associated custom attribute. During program execution when this code is reached, the late binder component 410 can be invoked. At this time, “x” should have a definite type. The late binder component 410 can then bind the type to a method “foo( ).” If no such member exists given the type, a runtime exception can be thrown or an error produced. Otherwise, the matching member can be invoked.

The dynamic type check component 420 can type check interactions amongst late bound code for programmatic errors. The dynamic type check component 420 analyzes such code in light of the language type system and/or defined types, among other things, in an attempt to identify type errors. For instance, if the bound object method “foo( )” results in an string in the above example, then a type error can be generated since the type is not the same as the assigned variable type and a string is not able to be converted to an integer.

It is to be noted that the late binder component 410 and the dynamic type check component 420 can be substantially similar to the early binder component 110 and the static type checker component 120 of system 100, respectively. In one instance, the functionality can be identical with the only difference being the time in which the functionality is applied, namely compile time or runtime. Accordingly, it should be appreciated that the late binder can also include the lookup component 210, overload component 220, type inference component 222 and cache component 210 as described with respect to FIG. 2. By way of example, upon determine of the runtime type of “x” the lookup component 210 can attempt to lookup the method “foo( )” with respect to a particular object “x.” If only a single method matches then that method can be bound. If, however, the member includes methods named “foo,” then the overload component 220 can attempt to resolve the situation by identifying a single matching “foo” as a function of parameters and argument types, among other things. Type inference component 222 can also be employed to infer method receiver types and/or generic method type parameters to facilitate method lookup or resolution. Likewise, the cache component 230 can be employed by the late binder component 410 to efficient bind with respect to loops and the like.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the type inference component 320 can employ such mechanisms to infer types. Similar means can be utilized by overload component 220 for overload resolution.

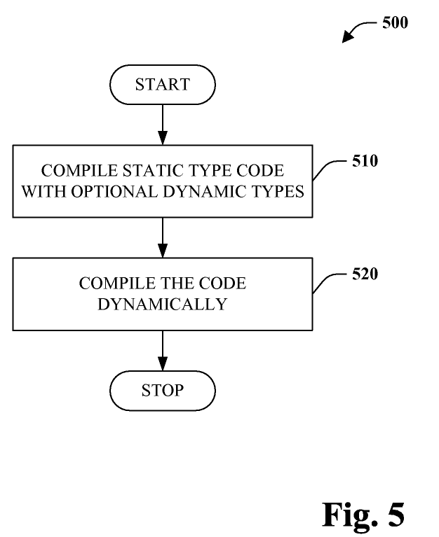

In view of the exemplary systems described supra, methodologies that may be implemented in accordance with the disclosed subject matter will be better appreciated with reference to the flow charts of FIGS. 5-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 5, a program translation method 500 is depicted in accordance with an aspect of the claimed subject matter. At reference numeral 510, static code including optional dynamic types is compiled. More specifically, the static code includes dynamic/late bound code identified by a special static type “dynamic,” for instance. The code can be compiled utilizing available static information while deferring binding of dynamic portions thereof. In one instance, the code can be compiled to an intermediate language representation. At reference numeral 520, the produced code is compiled dynamically at runtime. Here, any previously code previously identified as late bound can be bound. This action can be performed by a just-in-time (JIT) compiler, dynamic language translator or the like.

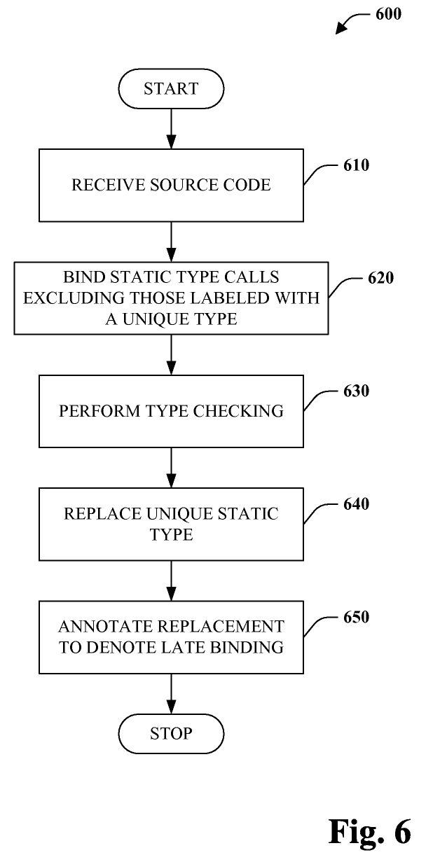

FIG. 6 is a flow chart diagram of a static compilation method 600. At reference numeral 610, source code is received. This source code can be statically typed including a plurality of normal static types as well as a special static type indicating the related code is late bound. At 620, member calls are bound with static types excluding those labeled with a unique or special static type. In particular, member lookup can be performed and conflict resolution performed where necessary based on a known static type. At numeral 630, type checking is performed with respect to the bound call. At reference 640, special static types are erased or replaced with normal/standard static types. For example, a special type “Dynamic” can be replace with an inferred type or a super type. The replacement type is annotated at reference numeral 650 to indicate late binding. Such annotation can include associated metadata, for example in the form of custom attributes, among other things.

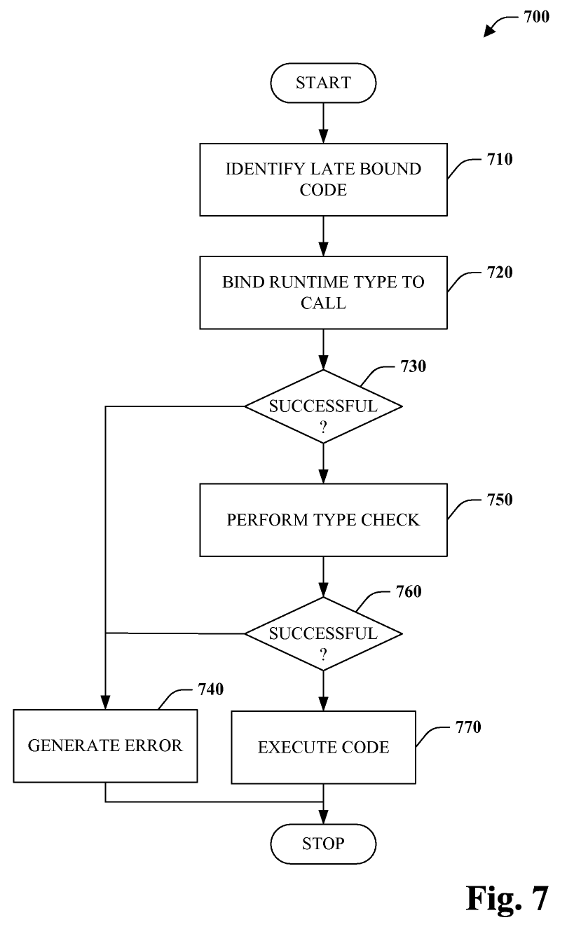

FIG. 7 illustrates a dynamic translation method 700 in accordance with an aspect of the claimed subject matter. At runtime, late bound code is identified at reference numeral 710. At 720, a call is attempted to be bound to a runtime type. For example, a method call “foo( )” in an expression “x.foo( )” is attempted to be bound to a runtime type of “x.” A determination is made at reference numeral 730 concerning whether or not code was successfully bound. If no, a runtime error or exception is generated at numeral 740 and the method terminates. If binding is successful, the method proceeds to numeral 750 where type checking is performed for code associated with a binding. For example, where an expression is associated with variable assignment a check is made to determine whether variable type is compatible with the assigned type. At numeral 760, a determination is made as to whether type checking was successful. If type checking was not successful, meaning a type error was found, the method continues at 740 where a runtime error is returned and the method terminates. If no errors where found at 760, the code is executed at numeral 770 and the method terminates successfully.

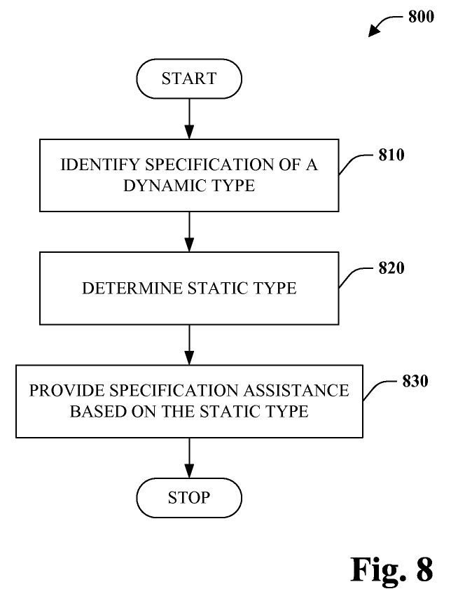

Turning to FIG. 8, a code development method 800 is depicted in accordance with one aspect of this disclosure. At reference numeral 810, specification of dynamic code within a static type language is identified. A static type associated with the dynamic code determined or identified a numeral 820. For example, such a type can be inferred from context associated with the dynamic code. Additionally or alternatively, a static type can be identified from an explicit specification thereof associated with the dynamic code, for example Dynamic<Button>. At reference numeral 830, code specification assistance is provided as a function of the static type. By way of example and not limitation, suggestions can be made and/or intelligent auto fill provided.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

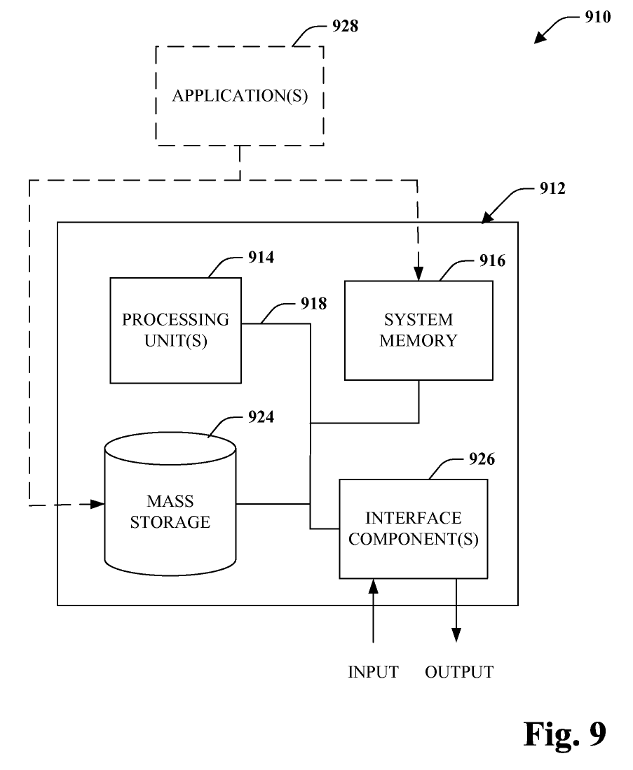

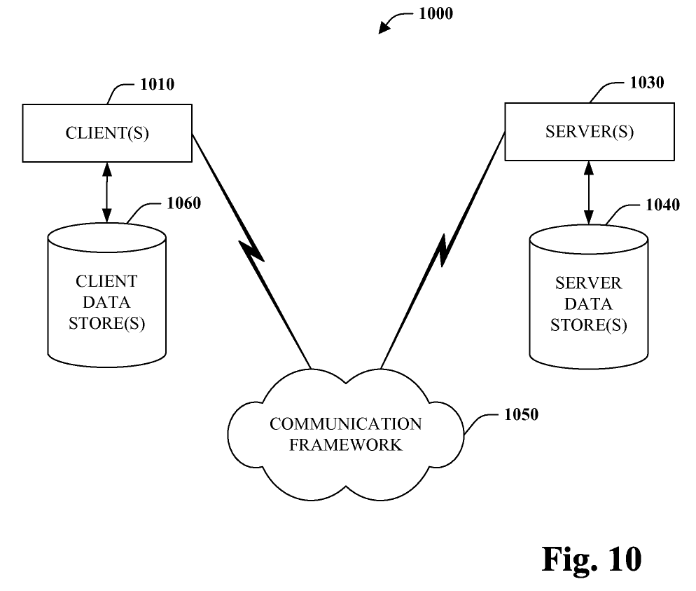

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 9, an exemplary environment 910 for implementing various aspects disclosed herein includes a computer 912 (e.g., desktop, laptop, server, hand held, programmable consumer or industrial electronics . . . ). The computer 912 includes a processing unit 914, a system memory 916 and a system bus 918. The system bus 918 couples system components including, but not limited to, the system memory 916 to the processing unit 914. The processing unit 914 can be any of various available microprocessors. It is to be appreciated that dual microprocessors, multi-core and other multiprocessor architectures can be employed as the processing unit 914.

The system memory 916 includes volatile and nonvolatile memory. The basic input/output system (BIOS), containing the basic routines to transfer information between elements within the computer 912, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 912 also includes removable/non-removable, volatile/non-volatile computer storage media. FIG. 9 illustrates, for example, mass storage 924. Mass storage 924 includes, but is not limited to, devices like a magnetic or optical disk drive, floppy disk drive, flash memory or memory stick. In addition, mass storage 924 can include storage media separately or in combination with other storage media.

FIG. 9 provides software application(s) 928 that act as an intermediary between users and/or other computers and the basic computer resources described in suitable operating environment 910. Such software application(s) 928 include one or both of system and application software. System software can include an operating system, which can be stored on mass storage 924, that acts to control and allocate resources of the computer system 912. Application software takes advantage of the management of resources by system software through program modules and data stored on either or both of system memory 916 and mass storage 924.

The computer 912 also includes one or more interface components 926 that are communicatively coupled to the bus 918 and facilitate interaction with the computer 912. By way of example, the interface component 926 can be a port (e.g., serial, parallel, PCMCIA, USB, FireWire . . . ) or an interface card (e.g., sound, video, network . . . ) or the like. The interface component 926 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 912 to output device(s) via interface component 926. Output devices can include displays (e.g., CRT, LCD, plasma . . . ), speakers, printers and other computers, among other things.

FIG. 10 is a schematic block diagram of a sample-computing environment 1000 with which the subject innovation can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the aspects of the subject innovation, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030. For example, programmers can develop and compile static code including a special static type indicative of late binding on one of client 1010 and server 1030. The compiled version can then be distributed across the communication framework 1050 for dynamic translation on multiple clients 1010 via related virtual machines.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A code analysis system, comprising:
an early binder component that binds types to elements at compile time exclusive of a special static type indicative of late binding; and
a static type check component that analyzes type usage associated with bindings and identifies any errors based on constraints of a language type system.

2. The system of claim 1, further comprising a replacement component that replaces the static type indicative of late binding with a replacement type.

3. The system of claim 2, the replacement component replaces the static type with a super type.

4. The system of claim 2, further comprising an inference component that infers a type from an associated element, the replacement component replaces the static type with the inferred type.

5. The system of claim 2, further comprising an annotation component that identifies a replacement type as dynamically typed.

6. The system of claim 5, further comprising:
a late binder component that binds types to elements associated with a dynamic type annotation at runtime; and
a dynamic type checker component that that analyzes type usage with respect to bindings to facilitate identification of type errors based on constraints of the language type system.

7. The system of claim 6, further comprising a cache component that temporarily stores results of a member lookup by the late binder component for loops to optimizing binding.

8. The system of claim 6, the dynamic type checker component compares a bound type to a static type and/or type constraint.

9. The system of claim 1, the static type is associated with at least one of constructed types, arguments and results.

10. A method of analyzing code, comprising:
acquiring object-oriented source code;
binding a type to a programmatic element at compile time exclusive of a unique static type indicative of late binding.

11. The method of claim 10, further comprising replacing the unique static type with another type to facilitate compile time binding.

12. The method of claim 11, replacing the unique static type with a super type.

13. The method of claim 11, further comprising:
inferring an element type; and
replacing the unique static type with the inferred type.

14. The method of claim 11, further comprising type checking the code utilizing the bindings.

15. The method of claim 11, further comprising annotating the replaced type with data that triggers late binding.

16. The method of claim 15, further comprising binding runtime types to elements including a late bound type annotation.

17. The method of claim 16, further comprising caching member lookups in a loop to facilitate optimized binding.

18. The method of claim 16, further comprising type checking the code utilizing late bound types.

19. A computer readable medium having stored thereon a data structure comprising:
a first source code element representing a programmatic construct; and
a second source code element representing a unique static type for the programmatic construct that indicates that the construct is to be type bound dynamically.

20. The computer readable medium of claim 19, the programmatic construct is one of a constructed type, argument type and result type.
